(19) United States
(12) Patent Application Publication
(10) Pub. No.: US 2007/0144216 A1
(43) Pub. Date: Jun. 28, 2007

(54) Method and a manufacturing apparatus for manufacturing a fiber preform

(76) Inventors: Kauko Janka, Tampere (FI); Tomi Forsblom, Lempaala (FI); Markku Rajala, Helsinki (FI); Harri Valkonen, Toijala (FI)

Correspondence Address: VENABLE LLP, P.O. BOX 34385, WASHINGTON, DC, 20043-9998, US

(21) Appl. No.: 10/554,082

(22) PCT Filed: Apr. 22, 2004
(86) PCT No.: PCT/FI04/50048

§ 371 Date: Nov. 13, 2006

(30) Foreign Application Priority Data
Apr. 22, 2003 (FI) 20030601

(51) Int. Cl. C03B 37/018; C03C 25/10

(52) U.S. Cl. 65/417; 65/529

(57) ABSTRACT

A method and manufacturing apparatus for forming one or several material layers inside a basic tube, which basic tube is used in the manufacture of an optical fiber preform. The surface inside the basic tube is electrically charged by guiding a first electrically charged gas flow inside the basic tube, whereafter a second electrically charged gas flow is guided into the basic tube. The gas flow contains material particles and the sequentially alternating first gas flow and second gas flow have opposite charges.

### BACKGROUND OF THE INVENTION

1. Field of the Invention

The invention relates to a method for manufacturing an optical fiber preform according to the preamble of the appended claim 1. The invention also relates to a manufacturing apparatus according to the preamble of the appended claim 6.

2. Description of the State of the Art

An optical fiber is typically formed by drawing the fiber from a fiber preform in a fiber drawing tower. The properties of the finished fiber for their part are determined on the basis of the properties of the fiber preform used in the process of drawing the fiber. The properties of the fiber preform, in turn, are determined on the basis of the manufacturing method and the manufacturing materials in use. The fiber preform can be formed in a number of different ways. Typically the fiber preform is grown around a tubular or a rod-like frame structure in layers. Often different materials are used in different layers in the process of growing the fiber preform in layers, by means of which materials different properties are formed in different layers of the fiber preform.

For example in the MCVD (Modified Chemical Vapor Deposition) method gaseous and vaporous raw materials are brought via a rotating connection inside a clean silica tube (i.e. a basic tube) attached to the jaws of a glass lathe. For evaporation of liquid raw materials containers designed especially for this purpose are used, in the lower part of which containers carrier gas is brought and from the upper part of the container a mixture of carrier gas and vapour is conveyed to the process. Typically used liquid raw materials with sufficiently high vapour pressure in room temperature include the main raw material of quartz glass, silicon tetrachloride (SiCl₄), germanium tetrachloride (GeCl₄) that increases the refractive index, as well as phosphorous oxytrichloride (POCl₃) that reduces the viscosity of glass and thus facilitates sintering. Furthermore, it is possible to use gases that reduce the refractive index, such as sulphur hexafluoride (SF₆) and other auxiliary gases, such as helium that improves the growing rate. The silica tube is heated from outside to a temperature of 1600 to 1800° C. with an oxygen/hydrogen burner attached to a back-and-forth moving carriage. The vapours and gases flowing inside the tube react with oxygen, thus forming very fine-grained glass dust. When the burner is moving, the burner propagating in the direction of the gas flow sinters the porous thin glass layer growing on the walls of the tube on the down-flow side of the burner as a result of thermophoresis. When the carriage of the burner reaches the other end of the tube, it returns to the starting point with a rapid movement. The number of glass layers to be grown varies between 20 and 100, depending on the fiber type. When all the necessary glass layers have been grown, the temperature of the tube is increased above the working temperature (softening temperature), approximately to 2000-2200° C., wherein the tube “collapses” as a result of surface tension and pressure difference, thus becoming a solid glass bar. The glass layers produced by means of the method are not constant in thickness in different sections of the tube, but thinner glass layers are typically formed at the ends of the tube than in the central part of the tube. In other sections of the tube the material thickness can vary as well, depending for example on the material flow and the movement of the burner. Furthermore, in said method the basic tube must be heated constantly, which, in turn, requires energy and sets limitations to the materials used in the manufacturing process.

European patent application EP0127041A1, in turn, discloses a manufacturing method for a fiber preform, in which new layers are grown electrostatically on the surface of a basic tube or rod functioning as a frame structure. In the method the particles forming the layer are charged, whereafter they are guided towards a counter-electrode and towards the surface of the basic structure. In one embodiment a counter-electrode is formed of the basic structure. In another embodiment the counter-electrode is placed around a tubular basic structure and the charged particles are fed via a nozzle arranged inside the basic tube, wherein the layers are formed inside the basic tube. In the method according to the publication, the nozzle feeding the particles moves only linearly in the longitudinal direction of the structure to be formed and said structure is arranged to rotate in relation to its axis. Thus, the particle flow of the nozzle can be directed substantially all over the structure to be treated. Due to the moving nozzles, it is difficult to implement the method according to the publication, and a counter-electrode is also necessary in said method.

### SUMMARY OF THE INVENTION

The main purpose of the present invention is to disclose a method to be used in the manufacture of a fiber preform, by means of which method it is possible to grow a new layer of material evenly and in a controlled manner inside a basic tube without nozzles moving inside the basic tube in the longitudinal direction of the tube.

To attain this purpose, the method according to the invention is primarily characterized in what will be presented in the characterizing part of the independent claim 1. The manufacturing apparatus according to the invention, in turn, is primarily characterized in what will be presented in the characterizing part of the independent claim 6.

The other, dependent claims will present some preferred embodiments of the invention.

The basic idea of the invention is to feed gas flows inside the basic tube in connection with the manufacture of the fiber preform, said gas flows being charged in such a manner that the charge of the gas flow changes periodically to the opposite sign. In this description the sequences are called a charge sequence and a collection sequence. During the charge sequence charging gas is fed through the basic tube until the inner surface reaches a balance charge. During the collection sequence gas containing charged particles is blown through the basic tube, wherein particles with an opposite charge with respect to the inner surface of the tube are accumulated on the inner surface of the tube by means of electrostatic attraction until the charge on the surface has been reversed. The charge sequence is repeated after the collection sequence so many times that the desired number of layers is formed.

A corona charger is advantageously used for charging the gas and the particles, wherein in some embodiments it is possible to use the same charge unit to produce charges of different signs. Because the charging of the fiber structure is conducted by means of a medium, it is not necessary to apply a nozzle moving inside the basic tube or separate conductors and/or electrodes.

The solution according to the invention makes it possible to grow a new material layer evenly on the entire length of the basic tube. Because it is possible to grow new layers on top of each other, it is also possible to produce desired profiles in the final fiber preform. The accurate control of the formation of layers has an especially advantageous effect in the manufacture of fiber preforms used in the production of active optical fibers.

With an embodiment according to the invention it is possible to attain a good growing efficiency and with another embodiment, in turn, good growing rate can be attained. With some embodiments of the invention it is also possible to utilize gases of wide temperature range, because the method according to the invention is not dependent on thermophoretic forces.

The fiber preform formed according to the invention is, in turn, advantageous in that respect that the glassworks performed thereon are easy.

### BRIEF DESCRIPTION OF THE DRAWINGS

In the following, the invention will be described in more detail with reference to the appended principle drawings, in which

FIGS. 1 to 4 show the different stages of a preferred embodiment of the method according to of the invention,

FIG. 5 shows a preferred embodiment of the apparatus according to the invention, in which a first and a second gas flow are fed from the same end of the basic tube,

FIG. 6 shows a second embodiment of the apparatus according to the invention, in which the first and the second gas flow are fed from opposite ends of the basic tube,

FIG. 7 shows a third embodiment of the apparatus according to the invention, in which the first and the second gas flow contain particles, and

FIG. 8 shows a fourth embodiment of the apparatus according to the invention, in which the charging of the gas flows is arranged by means of one. charger.

For the sake of clarity, the figures only show the details necessary for understanding the invention. The structures and details which are not necessary for understanding the invention and which are obvious for anyone skilled in the art have been omitted from the figures in order to emphasize the characteristics of the invention.

### DETAILED DESCRIPTION OF PREFERRED EMBODIMENTS

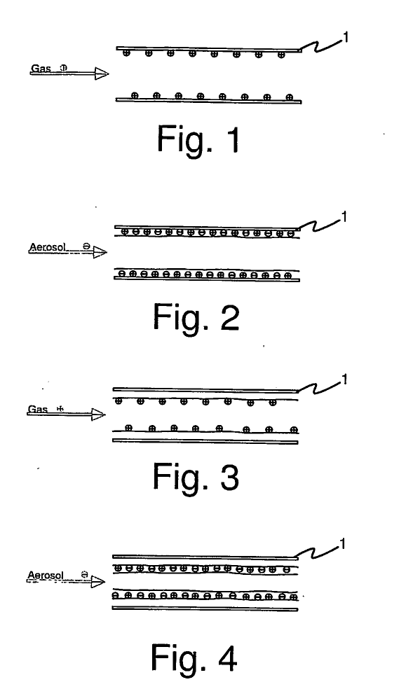

FIGS. 1 to 4 show a preferred embodiment of the method according to the invention in principle. FIG. 1 shows the charging process of a basic tube 1 that is typically made of quartz glass. In the example, a positively charged gas flow is guided inside the basic tube 1, said flow being marked with the word gas in the drawing. Advantageously, the gas in use is nitrogen or argon, in which an electric charge is produced by means of a suitable method, for example by means of a corona charger. From the gas flow the charge shifts to the surface layer 1 of the basic tube 1, and is divided substantially equally on the inner surface of the entire basic tube until the surface attains a balance charge, as shown in the drawing.

After the charging of the basic tube 1, a gas flow containing particles is guided into the basic tube, said gas flow being marked with the word aerosol in FIG. 2. Advantageously, the gas flow contains nitrogen or argon, among which suitable material particles are arranged. From the gas flow guided to the basic tube 1, the negatively charged particles gravitate on the surface of the charged basic tube in the manner shown in FIG. 2. When the particles and the basic tube 1 meet, the potential difference between them is equalized and when particles have accumulated evenly in each charged section of the basic tube, the charge of the tube is substantially reversed. At the same time a substantially even particle layer is formed.

The charge of the gas flow and especially the charge of the particles can be implemented in several different ways. One advantageous way is to charge the gas flow containing particles for example by means of a corona charger, wherein the charge substantially accumulates on the particles in the gas flow. Another advantageous way is to charge the particles with the charged gas flow, i.e. to arrange the particles in the charged gas after charging, wherein the charge shifts from the gas to the particle group rapidly and evenly.

If a second material layer is to be grown after growing the first material layer, the basic tube 1 must be charged again, in other words, as in this embodiment of the invention, when the first material layer has been grown, a charging gas flow is fed inside the basic tube again, according to FIG. 3. In the example, the basic tube 1 grown by one material layer is charged in a similar manner as the mere basic tube in FIG. 1, i.e. the inner surface of the grown basic tube is charged with a positively charged gas flow. Thus, the charge is distributed substantially evenly on the inner surface grown at an earlier stage. In another embodiment of the invention a gas flow is used for charging the inner surface, said gas flow containing layer-forming material, wherein a new material layer is also formed in connection with the charging process.

In FIG. 4 a gas flow is fed inside the positively charged basic tube 1, said gas flow containing negatively charged particles. In the example, the situation of FIG. 4 corresponds to the situation of FIG. 2 in which an first layer of material is grown inside the basic tube 1, with such a difference that one material layer has already been grown inside the basic tube, the new material layer being formed thereon.

The charging of the basic tube 1 and the growing of the material layer is repeated a sufficient number of times so that the desired layers are formed. Typically several tens and sometimes even hundreds of material layers are formed inside the basic tube 1. The method according to the invention can be utilized irrespective of the number of material layers to be formed. If necessary, the material layers can be sintered and the sintering can be performed between the formation of the material layers and/or when all material layers have been formed. The accurate control of the formation of material layers and the plurality of Variations of the different layers have. an especially advantageous effect in the manufacture of fiber preforms used in the production of active optical fibers.

When the desired number of material layers has been grown inside the basic tube 1, a fiber preform is typically formed of the basic tube by heating it above the softening temperature (typically 2000 to 2200° C.), wherein the tubular structure collapses, thus forming a solid rod.

FIGS. 1 to 4 show an embodiment according to the invention for forming material layers inside the basic tube 1, but it is possible to implement the formation of layers in several different ways according to the basic idea of the invention. For example the signs of the charges can deviate from those shown in the example, in other words the basic tube can be for example charged with a negative gas flow in the beginning. The structure and particle content of the gas flows can also vary, although typically the same gas or gas mixture is used as a charging gas in every charge sequence.

The above-presented formation of material layers inside the basic tube 1 can be implemented by means of a number of different apparatuses, of which a few most advantageous embodiments will be presented in the following.

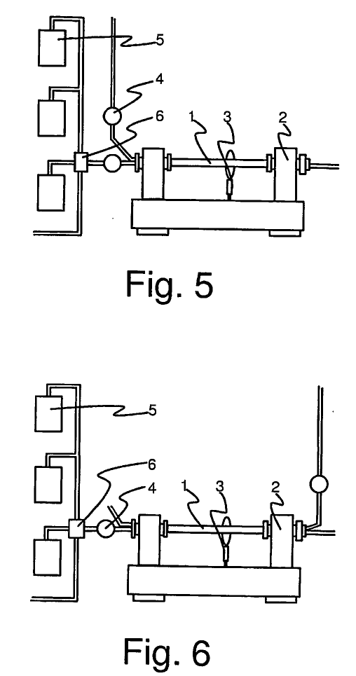

FIG. 5 shows an embodiment of the apparatus according to the invention, in which alternating gas flows are fed into the basic tube 1 of the fiber preform from the same end of the basic tube. Advantageously the basic tube 1 constituting the outer part of the fiber preform is manufactured of quartz glass, but it is also possible to utilize basic tubes made of other materials in accordance with the present invention. In the figure the basic tube 1 is placed into a glass lathe 2 for a thermal process, said thermal process constituting a part of the manufacturing process of the fiber preform. In a preferred embodiment the basic tube 1 is arranged to rotate with respect to its longitudinal axis. The basic tube 1 is arranged to be heated by a heating member 3, such as a burner or a furnace, which in the example is arranged to move in relation to the longitudinal axis of the basic tube. If necessary, the heating of the basic tube 1 during growing as well as the sintering and collapsing of the basic tube are conducted by means of the heating member 3. Suitable fuel gas and possible other gases used in the thermal process are brought to the heating member. The growing of the layers of the basic tube according to the invention is not, however, dependent on the above-presented glass lathe structure 1, but the growing of the layers according to the invention can be performed separately from the presented thermal process, and the tube structure grown electrostatically for the collapsing can be arranged into a separate process. For reasons relating to the manufacture it is, however, often advantageous to implement the combination of the processes in the manner shown in the example.

According to the invention, electrically charged gas flows are fed inside the basic tube 1. In the embodiment shown in FIG. 5 there are two chargers 4 of which the first one is utilized to charge the gas flow that produces the electrical charging of the inner surface of the basic tube 1. In this embodiment, the second charger 4 is utilized to charge the gas flow that contains constituents forming the new layer that are advantageously electrically charged particles, and preferably particles containing glass material. Typically the same gas that can be used as a carrier gas in the second gas flow is used in the first gas flow, and advantageously the gas can be nitrogen or argon. In the figure, three material feeding units 5, such as for example bubbling units are presented for the process of arranging the constituents as a part of the carrier gas, but the number of material feeding units may, of course, deviate from the presented number, or the constituents can be produced in the gas in other ways as well. In the example the gas is conveyed from the material feeding unit 5 via a particle forming unit 6 to the charger 4. The particle forming unit 6 may be a unit of any suitable type, but preferably it is a DND burner (Direct Nanoparticle Deposition), described for example in the Finnish patent FI 98832.

As a result of the first gas flow the inner surface of the basic tube 1 is charged. As a result of the high gas flow rate advantageously in use, the charge is distributed rapidly and evenly on the surface of the basic tube 1. After the first gas flow a second gas flow is guided to the basic tube 1, said gas flow being charged to an opposite sign with respect to the charge of the first gas flow. As a result of the mutual force effect of the electrical charges the charged particles contained in the second gas flow gravitate on the surface of the charged basic tube 1. By means of the electrical forces a substantially even material surface is formed on the inner surface of the basic tube 1. The constituents of the gas flow gravitate on the surface of the basic tube 1 to a considerable degree until the potential difference between the charges has been eliminated. Thereafter, if necessary, it is possible to repeat the charging of the basic tube 1 and the growing of the new material layer in the above-described manner. If necessary, the sintering of the material layers can be conducted in stages between the formation of different layers, or in the end of the process, when all the layers have been formed. When the desired number of material layers has been formed inside the basic tube 1, a fiber preform is typically produced of the basic tube by heating it above the working temperature, wherein the tubular structure collapses inside, thus forming a closed rod.

The charging of the gas flow and arranging the gas flow inside the basic tube 1 in accordance with the invention can be implemented in various ways, of which one advantageous way was presented above, and some other preferred ways will be described in the following. It is possible to combine the presented solutions with each other, thus producing solutions according to the invention which are not, however, described separately in this context.

FIG. 6 shows a second embodiment of the invention, in which gas flows are fed from both ends of the basic tube 1. In said embodiment a first charged gas flow is first supplied from the first end of the basic tube 1, and the inner surface of the basic tube is charged with said gas flow. Thereafter a second gas flow is fed from the second end of the basic tube 1, in which the charged constituents forming a new layer are supplied. The charged constituents of the second gas flow gravitate on the inner surface of the basic tube 1 charged as described above, thus forming a substantially even material layer. The constituents gravitate on the surface of the basic tube 1 substantially for such a long time that the difference between the charges disappears.

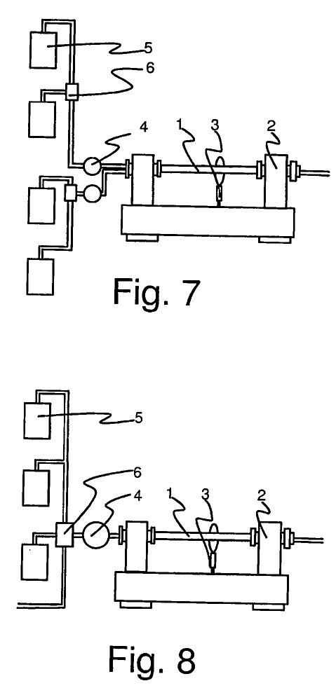

FIG. 7 shows a third embodiment of the invention in which the first and the second gas flow are supplied from the same end of the basic tube 1 via separate particle forming units 6 and chargers 4. This differs from the first embodiment in that respect that both the first and the second. gas flow comprise constituents forming the new layer. Such an arrangement is especially advantageous when several layers are formed in the basic tube 1.

FIG. 8, in turn, presents such an embodiment of the invention in which one charger 4 is used for charging gas flows of different signs. The apparatus comprises at least one material feeding unit 5 connected to the charger 4, but advantageously there are several material feeding units, as shown in the example. Thus, the first gas flow is supplied from the selected material feeding unit 5 to the basic tube 1 via a particle forming unit 6 and the charger 4. After the supply of the first gas flow the charging sign of the charger 4 is changed for the process of charging the second gas flow. The second gas flow is supplied either from the same material feeding unit 5 than the first gas flow or the feeding of material can be provided from another material feeding unit or other material feeding units. Thereafter the second gas flow is supplied to the basic tube 1 via the particle forming unit 6 and the charger 4. Such an arrangement is advantageous when several layers are formed that comprise same constituents, wherein the different constituents to be fed to different layers can be taken from the same material feeding units 5. The number and concentration of the constituents can vary in different layers when the material feeding units 5 are equipped with separately controlled control members, such as valves.

In one embodiment of the invention at least two fiber preforms are formed simultaneously in such a manner that the gas flows are guided alternately to different basic tubes 1. Thus, the production and charging of the gas flows can be conducted without interruptions.

The constituents used for growing the new layer of the basic tube 1 can be fed to the basic tube in particles arranged in the carrier gas and/or in gas within the scope of the present invention, irrespective of the location where the forming of the particle constituents takes place. The particles can be produced separately from the presented process, but it is advantageous to produce the particles ;in connection with the process, preferably with a DND burner. Furthermore, the particles may have other impacts, such as impacts relating to removal of iron and water.

Naturally, it will be obvious that the invention is not limited solely to the embodiments presented in the examples above, but it is for example possible to replace the particle forming unit 6 with a particle feeding unit, by means of which particles formed in another way are arranged to the charger 4. It is also possible to use material feeding units of several different types as material feeding units feeding the material to the particle forming unit 6 and the charger 4.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

1-11. (canceled)

12. A method for forming one or several material layers inside a basic tube, which basic tube is used in the manufacture of an optical fiber preform, wherein the method comprises one or several sequences of the following:
arranging an electrical charge in a first material;
guiding the electrically charged first material inside the basic tube;
arranging a charge on the inner surface of the basic tube by arranging the charge from the first material on the inner surface of the basic tube;
finishing guiding of the first material inside the basic tube;
arranging an electrical charge in a second material, said charge being opposite to the charge of the first material;
guiding the electrically charged second material inside the basic tube;
bringing the charged second material on the inner surface of the basic tube; and
finishing guiding of the second material inside the basic tube.

13. The method according to claim 12, wherein the first material comprises carrier gas, and the second material comprises particulate constructional material that forms the material layer.

14. The method according to claim 12, wherein the first material and the second material comprise particulate constructional material that forms the material layer.

15. The method according to claim 12, wherein the first material and the second material are guided to the basic tube from the same end of the basic tube.

16. The method according to claim 13, wherein the first material and the second material are guided to the basic tube from the same end of the basic tube.

17. The method according to claim 14, wherein the first material and the second material are guided to the basic tube from the same end of the basic tube.

18. The method according to claim 1, wherein the first material is guided to the basic tube from the first end of the basic tube and the second material is guided to the basic tube from the second end of the basic tube.

19. The method according to claim 13, wherein the first material is guided to the basic tube from the first end of the basic tube and the second material is guided to the basic tube from the second end of the basic tube.

20. The method according to claim 14, wherein the first material is guided to the basic tube from the first end of the basic tube and the second material is guided to the basic tube from the second end of the basic tube.

21. A manufacturing apparatus for forming one or several material layers inside a basic tube, which basic tube is intended to be used in the manufacture of an optical fiber preform, said manufacturing apparatus comprising:
means for electrically charging the first material electrically;
means for guiding the first material inside the basic tube for charging the basic tube;
means for charging the second material electrically in such a manner that the first and the second material have opposite charges;
means for conveying the second material inside the basic tube; and
means for alternating the first and the second material to be guided inside the basic tube.

22. The manufacturing apparatus according to claim 21, further comprising:
a first charger for charging the first material and a second charger for charging the second material.

23. The manufacturing apparatus according to claim 21, further comprising:
one charger whose polarity is changed sequentially for charging the first material and the second material.

24. The manufacturing apparatus according to claim 21, wherein the charger is a corona charger.

25. The manufacturing apparatus according to claim 22, wherein the charger is a corona charger.

26. The manufacturing apparatus according to claim 23, wherein the charger is a corona charger.

27. The manufacturing apparatus according to claim 21, further comprising:
at least one particle forming unit that is arranged to form particles in the gas flow.

28. The manufacturing apparatus according to claim 21, wherein the particle forming unit is a DND burner.

29. The manufacturing apparatus according to claim 11, wherein the particle forming unit is a DND burner.

30. The manufacturing apparatus according to claim 12, wherein the particle forming unit is a DND burner.

31. The manufacturing apparatus according to claim 24, wherein the particle forming unit is a DND burner.
